(19) United States
(12) Patent Application Publication
(10) Pub. No.: US 2023/0306999 A1
(43) Pub. Date: Sep. 28, 2023

(54) DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Kouichi TOUKAIRIN, Kawasaki Kanagawa (JP); Kenji MIZUOCHI, Kawasaki Kanagawa (JP); Hirofumi KURIBARA, Chuo Tokyo (JP); Hiroshi MINAMI, Yokohama Kanagawa (JP); Yasuhiko KATO, Setagaya Tokyo (JP); Yuya KINUGAWA, Yokohama Kanagawa (JP)

(21) Appl. No.: 17/941,718

(22) Filed: Sep. 9, 2022

(30) Foreign Application Priority Data
Mar. 22, 2022 (JP) 2022-045002

(51) Int. Cl. G11B 19/20; G11B 25/04

(52) U.S. Cl. CPC G11B 19/2036; G11B 25/043; H02K 5/1675

(57) ABSTRACT

According to one embodiment, a disk device includes a magnetic disk and a rotary unit. The magnetic disk is rotatable about a first rotation axis extending in the first direction. The rotary unit includes a rotary member, a bearing, and a first filter. The bearing contains a lubricant and rotatably supports the rotary member about a second rotation axis. The first filter captures at least one component contained in the lubricant. The rotary member is provided with a hole and a first communication port. The hole extends along the second rotation axis to accommodate the bearing. The first communication port extends in a direction intersecting the second rotation axis to allow the hole to be in communication with an outside of the rotary member. The first filter is disposed in the first communication port or covers the first communication port.

### CROSS-REFERENCE TO RELATED APPLICATIONS

This application is based upon and claims the benefit of priority from Japanese Patent Application No. 2022-045002, filed on Mar. 22, 2022, the entire contents of which are incorporated herein by reference.

### FIELD

Embodiments described herein relate generally to a disk device.

### BACKGROUND

A disk device such as a hard disk drive includes, for example, a magnetic disk, a magnetic head, and an actuator that moves the magnetic head with respect to the magnetic disk. The actuator includes a suspension that holds the magnetic head, a carriage to which the suspension is attached, and a bearing that rotatably supports the carriage.

Along with the rotation of the magnetic disk, a flow of gas occurs along the surface of the magnetic disk. In addition, a lubricant contained in the bearing may turn to gas or mist and be flown to the outside of the carriage. Such a lubricant, if carried by the gas flow, may contaminate the inside of the disk device.

### BRIEF DESCRIPTION OF THE DRAWINGS

FIG. 1 is an exemplary plan view illustrating a hard disk drive (HDD) according to a first embodiment;

FIG. 2 is an exemplary cross-sectional view illustrating a part of the HDD of the first embodiment along line F2-F2 of FIG. 1;

FIG. 3 is an exemplary plan view schematically illustrating an actuator assembly of the first embodiment;

FIG. 4 is an exemplary plan view schematically illustrating an actuator assembly according to a second embodiment;

FIG. 5 is an exemplary cross-sectional view illustrating a part of the HDD of the second embodiment along line F5-F5 of FIG. 4;

FIG. 6 is an exemplary plan view schematically illustrating an actuator assembly according to a third embodiment;

FIG. 7 is an exemplary cross-sectional view illustrating a part of the HDD of the third embodiment along line F7-F7 of FIG. 6;

FIG. 8 is an exemplary plan view schematically illustrating an actuator assembly according to a fourth embodiment;

FIG. 9 is an exemplary cross-sectional view illustrating a part of the HDD of the fourth embodiment along line F9-F9 in FIG. 8; and

FIG. 10 is an exemplary cross-sectional view illustrating a part of an HDD 10 according to a fifth embodiment.

### DETAILED DESCRIPTION

In general, according to one embodiment, a disk device includes a magnetic disk and a rotary unit. The magnetic disk is rotatable about a first rotation axis extending in the first direction, and has a recording surface facing a first direction. The rotary unit includes a rotary member, a bearing, and a first filter. The bearing contains a lubricant and rotatably supports the rotary member about a second rotation axis extending in the first direction, the second rotation axis being apart from the first rotation axis in a second direction orthogonal to the first direction. The first filter captures at least one component contained in the lubricant. The rotary member is provided with a hole and a first communication port. The hole extends along the second rotation axis to accommodate the bearing. The first communication port extends in a direction intersecting the second rotation axis to allow the hole to be in communication with an outside of the rotary member. The first filter is disposed in the first communication port or covers the first communication port.

### First Embodiment

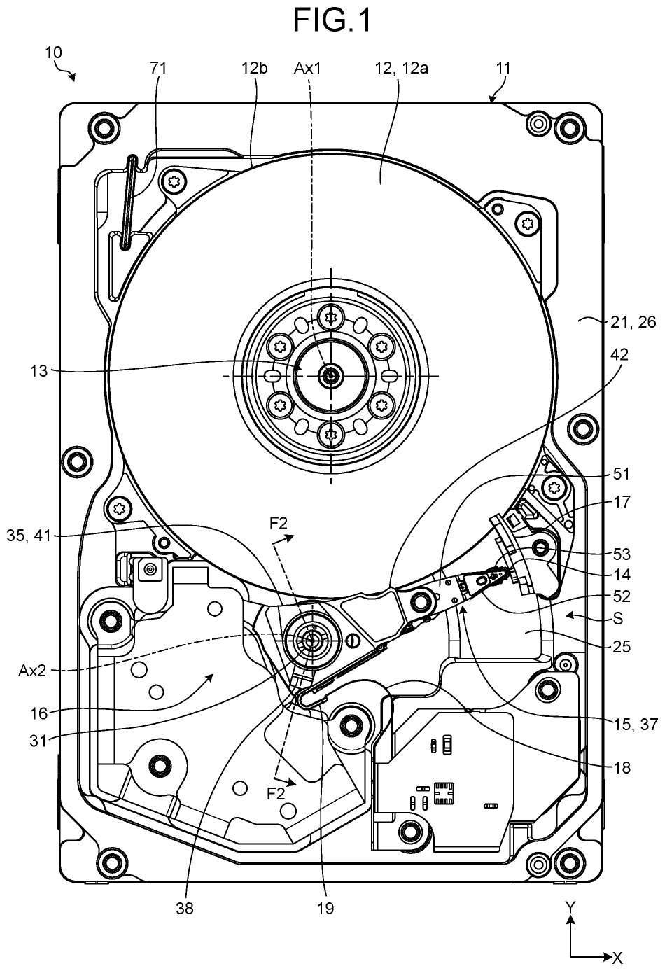

Hereinafter, a first embodiment will be described with reference to FIGS. 1 to 3. Note that, in the present specification, components according to embodiments and descriptions of the components may be described in a plurality of expressions. The components and the description thereof are examples, and are not limited by the expression of the present specification. The components may also be identified with names different from those herein. In addition, the components may be described by expressions different from expressions in the present specification.

FIG. 1 is an exemplary plan view illustrating a hard disk drive (HDD) 10 according to a first embodiment. The HDD 10 is an example of a disk device, and may also be referred to as an electronic device, a storage device, an external storage device, or a magnetic disk device.

As illustrated in the drawings, in the present specification, an X axis, a Y axis, and a Z axis are defined for convenience. The X axis, the Y axis, and the Z axis are orthogonal to each other. The X axis is provided along a width of the HDD 10. The Y axis is provided along a length of the HDD 10. The Z axis is provided along a thickness of the HDD 10.

Furthermore, in the present specification, an X direction, a Y direction, and a Z direction are defined. The X direction is a direction along the X axis and includes a +X direction indicated by an arrow of the X axis and a −X direction which is an opposite direction of the arrow of the X axis. The Y direction is a direction along the Y axis and includes a +Y direction indicated by an arrow of the Y axis and a −Y direction which is an opposite direction of the arrow of the Y axis. The Z direction is a direction along the Z axis and includes a +Z direction indicated by an arrow of the Z axis and a −Z direction which is an opposite direction of the arrow of the Z axis.

As illustrated in FIG. 1, the HDD 10 includes a housing 11, a plurality of magnetic disks 12, a spindle motor 13, a plurality of magnetic heads 14, an actuator assembly 15, a voice coil motor (VCM) 16, a ramp load mechanism 17, a flexible printed circuit board (FPC) 18, and a retainer 19. The magnetic heads 14 may also be referred to as sliders. The actuator assembly 15 is an example of the rotary unit.

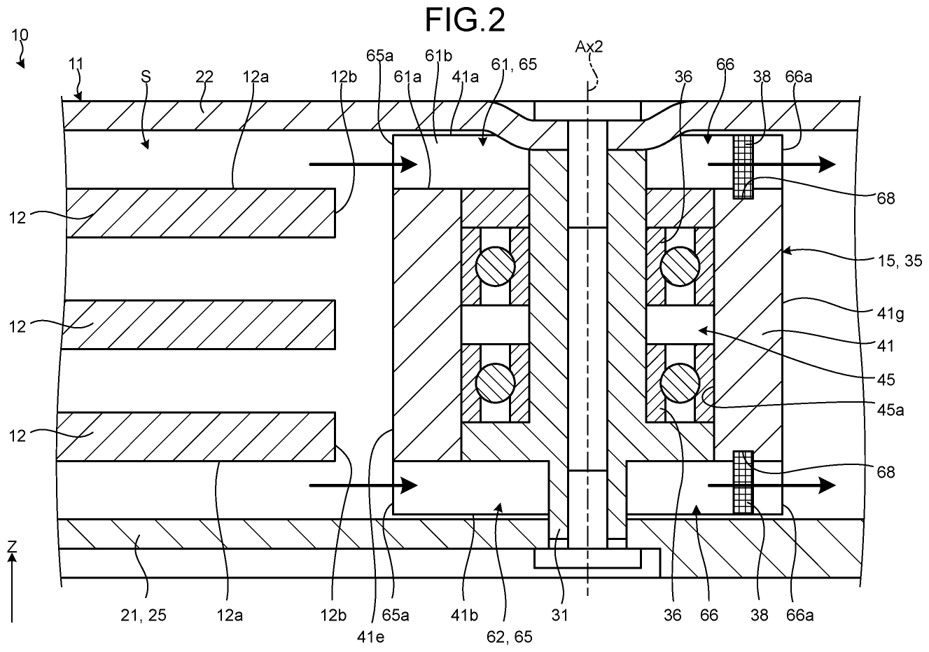

FIG. 2 is an exemplary cross-sectional view illustrating a part of the HDD 10 of the first embodiment along line F2-F2 of FIG. 1. As illustrated in FIG. 2, the housing 11 includes a base 21 and a cover 22. Note that the housing 11 is not limited to this example.

The base 21 is made of a metal material such as an aluminum alloy, for example, and has a substantially rectangular parallelepiped box shape open in the +Z direction. As illustrated in FIG. 1, the base 21 has a bottom wall 25 and a side wall 26.

The bottom wall 25 has a substantially rectangular (quadrangular) plate shape extending along an X-Y plane. The side wall 26 projects substantially in the +Z direction from the edge of the bottom wall 25 and has a substantially rectangular frame shape. The bottom wall 25 and the side wall 26 are integrated together.

The cover 22 illustrated in FIG. 2 is made of, for example, a metal material such as an aluminum alloy. The cover 22 is attached to an end of the side wall 26 in the +Z direction with, for example, screws or by welding.

The housing 11 has an inner chamber S. The inner chamber S is formed, defined, or partitioned by, for example, the bottom wall 25, the side wall 26, and the cover 22. The inner chamber S is filled with a gas different from air. For example, the inner chamber S is filled with a low density gas having a density lower than air, or an inert gas having low reactivity. In the present embodiment, the inner chamber S is filled with helium. Note that the inner chamber S may be filled with another fluid.

The plurality of magnetic disks 12 extends along the X-Y plane. The magnetic disks 12 have a diameter of, for example, 2.5 inches. Note that the diameter of the magnetic disk 12 is not limited to this example. Each of the magnetic disks 12 has at least one recording surface 12a and an outer edge 12b. The outer edge 12b is an example of an end of the magnetic disk.

Each magnetic disk 12 has the recording surface or surfaces 12a on at least one of the upper and lower sides. In other words, the recording surfaces 12a of the magnetic disks 12 face substantially the +Z direction or substantially the −Z direction. The +Z direction is an example of the first direction.

The recording surface 12a is a substantially flat surface extending along the X-Y plane. The magnetic disk 12 includes a magnetic recording layer on the recording surface 12a. Note that the magnetic recording layer may not be provided on a part of the recording surface 12a. The outer edge 12b is an outer circumference of the magnetic disk 12.

The plurality of magnetic disks 12 is stacked at intervals in the Z direction. The spindle motor 13 illustrated in FIG. 1 has a hub that supports a plurality of magnetic disks 12. The plurality of magnetic disks 12 is held by the hub of the spindle motor 13 with, for example, a clamp spring.

The spindle motor 13 rotates the plurality of magnetic disks 12 about a first rotation axis Ax1. The first rotation axis Ax1 is a virtual axis extending substantially in the Z direction (+Z direction and −Z direction). That is, the first rotation axis Ax1 extends in a direction orthogonal (intersecting) to the recording surface 12a.

The first rotation axis Ax1 matches the center of rotation of the spindle motor 13 and the axis of the magnetic disk 12 and the hub of the spindle motor 13. Note that the axis of the magnetic disk 12 and the axis of the hub of the spindle motor 13 may be different from the center of rotation of the spindle motor 13.

The magnetic head 14 records and reproduces information on and from the recording surface 12a of the magnetic disk 12. In other words, the magnetic head 14 reads and writes information from and to the recording surface 12a of the magnetic disk 12. The magnetic head 14 is mounted on the actuator assembly 15.

The actuator assembly 15 is rotatably supported by a support shaft 31 disposed away from the magnetic disk 12. The support shaft 31 extends, for example, substantially in the +Z direction from the bottom wall 25 of the housing 11.

The actuator assembly 15 can rotate about a second rotation axis Ax2 apart from the first rotation axis Ax1. The second rotation axis Ax2 is a virtual axis extending substantially in the Z direction (+Z direction and −Z direction). Thus, the first rotation axis Ax1 and the second rotation axis Ax2 are substantially in parallel. The second rotation axis Ax2 matches, for example, the center of rotation of the actuator assembly 15 and the axis of the support shaft 31.

In the present specification, an axial direction, a radial direction, and a circumferential direction are defined. The axial direction is a direction along a virtual axis such as the first rotation axis Ax1 and the second rotation axis Ax2, and includes one direction and the other direction along the axis. The radial direction is a direction orthogonal to the axis, and includes a plurality of directions orthogonal to the axis. The circumferential direction is a direction of rotation around the axis, and includes a direction of clockwise rotation and a direction of counterclockwise rotation around the axis.

As described above, the first rotation axis Ax1 and the second rotation axis Ax2 extend substantially in parallel in the substantially Z direction and are separated from each other. That is, the axial direction of the first rotation axis Ax1 and the axial direction of the second rotation axis Ax2 are the Z direction. The second rotation axis Ax2 is separated from the first rotation axis Ax1 in the radial direction of the first rotation axis Ax1. A radial direction of the first rotation axis Ax1 is a direction orthogonal to the Z direction, and is an example of the second direction.

The VCM 16 rotates the actuator assembly 15 about the second rotation axis Ax2 to place the actuator assembly 15 in a desired position. As the actuator assembly 15 is rotated by the VCM 16, the magnetic head 14 moves to the outermost periphery of the magnetic disk 12, and the ramp load mechanism 17 holds the magnetic head 14 at a position apart from the magnetic disk 12.

The actuator assembly 15 includes a carriage 35 and a plurality of bearings 36 illustrated in FIG. 2 and a plurality of head suspension assemblies (suspensions) 37 and a filter 38 illustrated in FIG. 1. The carriage 35 is an example of the rotary member and a carriage. The suspensions 37 may also be referred to as head gimbal assemblies (HGA). The filter 38 is an example of the first filter.

The carriage 35 is made of a metal material such as an aluminum alloy. Note that the material of the carriage 35 is not limited to this example. The carriage 35 includes an actuator block 41 and a plurality of arms 42.

As illustrated in FIG. 2, the actuator block 41 has a substantially cylindrical shape extending along the second rotation axis Ax2. The actuator block 41 is provided with a hole 45 inside. The hole 45 extends along the second rotation axis Ax2 and penetrates the actuator block 41 in the Z direction. In other words, the hole 45 extends in the axial direction of the second rotation axis Ax2, and the second rotation axis Ax2 extends through the hole 45.

The actuator block 41 has an inner surface 45a of the hole 45. The inner surface 45a is a substantially cylindrical surface that forms, defines, or partitions the hole 45. The inner surface 45a faces the second rotation axis Ax2.

The support shaft 31 extends in the Z direction through the hole 45. The inner surface 45a of the hole 45 faces the support shaft 31 with an interval. The plurality of bearings 36 is disposed between the inner surface 45a of the hole 45 and the support shaft 31. In other words, the plurality of bearings 36 is housed in the hole 45.

The bearings 36 are, for example, ball bearings. Note that the bearings 36 may be other types of bearings. The inner race of the bearings 36 is fixed to the support shaft 31. The outer race of the bearings 36 is fixed to the inner surface 45a of the hole 45.

The bearings 36 rotatably support the carriage 35 about the second rotation axis Ax2. Thus, the carriage 35 is rotatable about the second rotation axis Ax2 but is restricted from moving in the radial direction of the second rotation axis Ax2 by the support shaft 31 and the bearings 36.

The bearings 36 contain, accommodate, or include a lubricant. The lubricant lubricates the bearings 36 between the inner race and the ball and between the ball and the outer race. In the present embodiment, the lubricant is, for example, grease. Note that the lubricant is not limited to this example, and may be another lubricant such as lubricating oil.

The plurality of arms 42 illustrated in FIG. 1 projects from the actuator block 41 in the radial direction of the second rotation axis Ax2. Note that the actuator assembly 15 may be divided so that the arms 42 can project from the corresponding actuator blocks 41.

The plurality of arms 42 is disposed at intervals in the axial direction of the second rotation axis Ax2. Each of the arms 42 has a plate shape to enter a gap between the adjacent magnetic disks 12. The plurality of arms 42 extends substantially in parallel.

The actuator block 41 is provided with a protrusion protruding to the opposite side of the arms 42, the protrusion on which a voice coil of the VCM 16 is placed. The VCM 16 includes a pair of yokes, the voice coil disposed between the yokes, and magnets placed on the yokes.

As described above, the VCM 16 rotates the actuator assembly 15 about the second rotation axis Ax2. In other words, the VCM 16 integrally rotates (moves) the actuator block 41, the arms 42, and the suspensions 37 about the second rotation axis Ax2.

Each suspension 37 is attached to a distal end of the corresponding arm 42 and projects from the arm 42. Thus, the suspensions 37 are disposed at intervals in the axial direction of the second rotation axis Ax2. Each of the suspensions 37 includes a base plate 51, a load beam 52, and a flexure 53.

The base plate 51 and the load beam 52 are made of, for example, stainless steel. Note that the base plate 51 and the load beam 52 may be made of other materials or may be made of materials different from each other.

The base plate 51 is attached to the distal end of the arm 42. The load beam 52 is attached to the distal end of the base plate 51 and projects from the base plate 51 in the radial direction of the second rotation axis Ax2. In other words, the load beam 52 extends in the radial direction of the second rotation axis Ax2.

The load beam 52 has a thinner thickness than the base plate 51 and a plate shape extending along the X-Y plane. That is, the load beam 52 is supported by the base plate 51 in a cantilever manner, and can be bent with one end attached to the base plate 51 as a fulcrum.

The flexure 53 has an elongated belt shape. Note that the shape of the flexure 53 is not limited to this example. The flexure 53 is, for example, a multilayer plate including a metal plate (backing layer) of stainless steel, an insulating layer formed on the metal plate, a conductive layer formed on the insulating layer and having a plurality of wires (wiring patterns), and a protective layer (insulating layer) covering the conductive layer.

The flexure 53 is attached to the base plate 51 and the load beam 52. The flexure 53 includes a displaceable gimbal (elastic support) at one end and above the load beam 52. The magnetic head 14 is held by the gimbal. The other end of the flexure 53 is connected to the FPC 18. Thus, the FPC 18 is electrically connected to the magnetic head 14 via the wiring of the flexure 53.

One end of the FPC 18 is connected to the flexure 53 as described above. The one end of the FPC 18 is held by a retainer 19 attached to the actuator block 41.

The other end of the FPC 18 is connected to a substrate disposed outside the housing 11 via a connector provided in the housing 11, for example. For example, a controller that controls the entire HDD 10 and an interface connector connected to the host computer are mounted on the substrate. The substrate is electrically connected to the magnetic head 14 via the FPC 18 and the flexure 53.

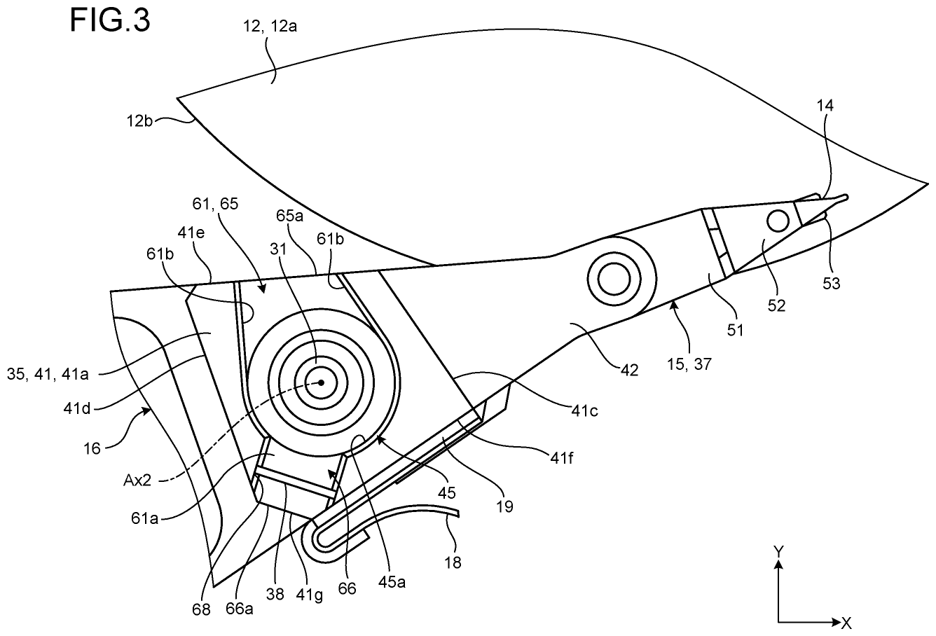

FIG. 3 is an exemplary plan view schematically illustrating the actuator assembly 15 of the first embodiment. The actuator block 41 has two end surfaces 41a and 41b illustrated in FIG. 2 and five outer surfaces 41c, 41d, 41e, 41f, and 41g illustrated in FIG. 3. The end surface 41a is an example of an end of the carriage in the first direction. The outer surface 41e is an example of a second outer surface. The outer surface 41g is an example of a first outer surface.

As illustrated in FIG. 2, the end surface 41a is located at an end of the actuator block 41 in the +Z direction. The end surface 41a is substantially flat and faces the +Z direction. The end surface 41b is located at an end of the actuator block 41 in the −Z direction. The end surface 41b is substantially flat and faces the −Z direction. Note that the end surfaces 41a and 41b are not limited to this example.

As illustrated in FIG. 3, the outer surfaces 41c, 41d, 41e, 41f, and 41g are substantially flat and face outward in the radial direction of the second rotation axis Ax2. The outer surfaces 41c, 41d, 41e, 41f, and 41g form a substantially quadrangular cylindrical shape as a whole, and extend in the substantially Z direction between the edge of the end surface 41a and the edge of the end surface 41b.

The plurality of arms 42 projects from the outer surface 41c. Thus, the outer surface 41c faces the magnetic head 14 and the suspension 37. The outer surface 41d is opposite the outer surface 41c. The protrusion on which the voice coil is placed protrudes from the outer surface 41d.

The outer surface 41e extends between one end of the outer surface 41c and one end of the outer surface 41d. The outer surface 41e faces the outer edge 12b of the magnetic disk 12. The direction in which the outer surface 41e faces is a direction intersecting the second rotation axis Ax2, and is an example of a fourth direction.

The outer surface 41f is opposite the outer surface 41e. The outer surface 41f extends between the other end of the outer surface 41c and the other end of the outer surface 41d. The retainer 19 is attached to the outer surface 41d with, for example, screws.

The outer surface 41g is located in a corner area between the outer surface 41d and the outer surface 41f. The outer surface 41g is substantially flat. The outer surface 41g faces a direction intersecting the second rotation axis Ax2, which is an example of a third direction. The outer surface 41g and the outer surface 41e face different directions.

As illustrated in FIG. 2, the actuator block 41 is provided with two grooves 61 and 62. The groove 61 is an example of the first communication port. The groove 61 is recessed from the end surface 41a of the actuator block 41. As illustrated in FIG. 3, in the direction intersecting the second rotation axis Ax2, the groove 61 extends between the outer surface 41e and the outer surface 41g. The groove 61 has an upstream part 65 and a downstream part 66. The upstream part 65 and the downstream part 66 are a part of the groove 61 and are both recessed from the end surface 41a.

The upstream part 65 extends in the radial direction of the second rotation axis Ax2 and communicates with the hole 45 and the outer surface 41e. That is, the upstream part 65 allows the hole 45 to communicate with the outside of the carriage 35. The radial direction of the second rotation axis Ax2 is an example of the direction intersecting the second rotation axis. The upstream part 65 may extend in another direction intersecting the second rotation axis Ax2.

The upstream part 65 has an upstream opening 65a. The upstream opening 65a is an example of a second opening. The upstream opening 65a is an end of the upstream part 65 in the outer surface 41e. The upstream opening 65a faces the outer edge 12b of the magnetic disk 12.

The downstream part 66 extends in the radial direction of the second rotation axis Ax2 and communicates with the hole 45 and the outer surface 41g. That is, the downstream part 66 allows the hole 45 to communicate with the outside of the carriage 35. Further, the downstream part 66 communicates with the upstream part 65 in the vicinity of the hole 45. The downstream part 66 may extend in another direction intersecting the second rotation axis Ax2.

The downstream part 66 has a downstream opening 66a. The downstream opening 66a is an example of a first opening. The downstream opening 66a is an end of the downstream part 66 in the outer surface 41g. The downstream opening 66a is apart from the upstream opening 65a.

The upstream opening 65a is closer to the first rotation axis Ax1 and the magnetic disk 12 than the downstream opening 66a. The groove 61 extends through the hole 45 between the upstream opening 65a and the downstream opening 66a.

The actuator block 41 further has a bottom surface 61a and two side surfaces 61b of the groove 61. The bottom surface 61a is a bottom of the groove 61 in the −Z direction. The −Z direction is an example of a direction opposite to the first direction. The bottom surface 61a is substantially flat and faces the +Z direction. Note that the bottom surface 61a is not limited to this example. The two side surfaces 61b extend substantially in the +Z direction from the bottom surface 61a and face each other. The groove 61 is formed, defined, or partitioned by the two side surfaces 61b.

As illustrated in FIG. 2, the bottom surface 61a is substantially at the same position as the recording surface 12a of the corresponding magnetic disk 12 in the Z direction. The Z direction is an example of a direction along the first rotation axis. For example, the bottom surface 61a is at substantially the same position as one recording surface 12a of the magnetic disk 12 closest to the cover 22 in the Z direction. Note that the bottom surface 61a may be apart from the corresponding recording surface 12a in the −Z direction.

Due to the above-described arrangement of the bottom surface 61a, at least a part of the upstream opening 65a is located at the same position as the recording surface 12a of the corresponding magnetic disk 12 in the Z direction. In the present embodiment, in the Z direction, at least a part of the upstream opening 65a is at the same position as the radially outer end of the recording surface 12a with respect to the first rotation axis Ax1. It may be sufficient that the upstream opening 65a and the corresponding recording surface 12a are at least partially at the same position in the Z direction.

The hole 45 is open to the bottom surface 61a. The support shaft 31 or the carriage 35 may include a lid that closes the hole 45. In this case, however, the hole 45 and the groove 61 can communicate with each other through a slight gap between the lid and the inner surface 45a of the hole 45.

An end of the groove 61 in the +Z direction is closed by the cover 22. Thus, the groove 61 forms a flow path extending between the upstream opening 65a and the downstream opening 66a. The downstream opening 66a is not closed by the FPC 18 and the retainer 19 but communicates with the inner chamber S.

The groove 62 is substantially mirror-symmetrical to the groove 61 in terms of shape. That is, the shape of the groove 62 is understandable from the description of the shape of the groove 61 by replacing the −Z direction with the +Z direction. Note that the groove 61 and the groove 62 may have different shapes.

As with the groove 61, the groove 62 has an upstream part 65 and a downstream part 66. The end of the groove 62 in the −Z direction is closed by the bottom wall 25. Thus, the groove 62 forms a flow path extending between the upstream opening 65a and the downstream opening 66a.

The filter 38 is a nonwoven fabric made of, for example, polytetrafluoroethylene (PTFE). The filter 38 has a sheet form. Note that the filter 38 is not limited to this example. The filter 38 can capture at least one component of the lubricant contained in the bearings 36.

The filter 38 is placed in the groove 61. For example, the filter 38 is placed in the downstream part 66. In other words, the filter 38 is located between the downstream opening 66a and the hole 45.

In the present embodiment, the bottom surface 61a and the two side surfaces 61b of the downstream part 66 are provided with a groove 68. The groove 68 is open to the bottom surface 61a and the two side surfaces 61b. The edge of the filter 38 is fitted into the groove 68 and fixed by adhesion, for example. Thus, the filter 38 is attached to the carriage 35. Note that the filter 38 may be attached to the carriage 35 by another method.

The filter 38 protrudes in the +Z direction from the bottom surface 61a of the groove 61. Furthermore, the filter 38 extends between the two side surfaces 61b. Thus, the filter 38 closes the downstream part 66 but allows the gas to pass therethrough. Note that the filter 38 is not limited to this example.

In the HDD 10 according to the first embodiment described above, the gas (for example, helium) flows from the inner chamber S along the recording surface 12a of the magnetic disk 12 while being rotated about the first rotation axis Ax1 by the spindle motor 13.

As indicated by the arrow in FIG. 2, the gas flows to the outside in the radial direction of the first rotation axis Ax1 by the centrifugal force. The gas flow reaches the outer edge 12b of the magnetic disk 12 and is discharged from the outer edge 12b in a direction along a tangent of the outer edge 12b.

As described above, the upstream opening 65a faces the outer edge 12b. Furthermore, in the Z direction, at least a part of the upstream opening 65a is at the same position as the recording surface 12a of the corresponding magnetic disk 12. Thus, discharged from the outer edge 12b, the gas flow flows into the grooves 61 and 62 from the upstream opening 65a.

Meanwhile, the lubricant in the bearings 36 may become gaseous or misty. The lubricant in the form of gas or mist flows out from the hole 45 to the grooves 61 and 62. Note that the lubricant in the form of gas or mist may be at least one gaseous or misty component among the components contained in the lubricant.

The gas flow flowing into the grooves 61 and 62 from the upstream opening 65a flows toward the downstream opening 66a. The gaseous or misty lubricant is carried by the gas flow toward the downstream opening 66a. The lubricant merging in the gas flow is captured by the filter 38. The gas flow passes through the filter 38 and is discharged from the downstream opening 66a to the inner chamber S.

After, the gas flow having the lubricant removed by the filter 38 is sucked into the rotating magnetic disk 12. Note that the gas may flow along the side wall 26, for example. In this manner, the gas flow circulates in the inner chamber S through the grooves 61 and 62.

The gas flow, while sucked into the magnetic disk 12, may pass near the magnetic head 14. If the gas flow contains a gaseous or misty lubricant, the lubricant may adheres to the magnetic head 14, hindering the operation of the magnetic head 14. However, the HDD 10 of the present embodiment includes the filter 38 to capture the lubricant, to be able to prevent hindrance to the operation of the magnetic head 14.

As illustrated in FIG. 1, the HDD 10 further includes a filter 71. The filter 71 is attached to the side wall 26 in the inner chamber S. The filter 71 can remove the lubricant carried by the gas flow flowing along the side wall 26.

In the HDD 10 according to the first embodiment described above, the magnetic disk 12 has the recording surface 12a facing the +Z direction and is rotatable about the first rotation axis Ax1 extending in the +Z direction. The actuator assembly 15 includes the carriage 35, the bearings 36, and the filter 38. The bearings 36 rotatably support the carriage 35 about the second rotation axis Ax2 and contain lubricant. The second rotation axis Ax2 is apart from the first rotation axis Ax1 in the radial direction of the first rotation axis Ax1 and extends in the +Z direction. The filter 38 can capture at least one component contained in the lubricant. The carriage 35 is provided with the hole 45 and the groove 61. The hole 45 extends along the second rotation axis Ax2 and accommodates the bearings 36. The groove 61 extends in a direction intersecting the second rotation axis Ax2 and allows the hole 45 to communicate with the outside of the carriage 35. The filter 38 is disposed in the groove 61. The magnetic disk 12 being in rotation causes a gas flow flowing along the recording surface 12a to the radially outside of the first rotation axis Ax1. For example, the lubricant in the bearings 36 may become gaseous or misty and be carried by the gas flow, which may result in contaminating the inside of the HDD 10. In view of this, the filter 38 is disposed in the groove 61 communicating with the hole 45 accommodating the bearings 36 and the outside of the carriage 35. Thus, the gaseous or misty lubricant is captured by the filter 38 before being carried by the gas flow. Consequently, the HDD 10 of the present embodiment can prevent the inside of the HDD 10 from being contaminated by the gaseous or misty lubricant.

The carriage 35 has the outer surface 41g facing the direction intersecting the second rotation axis Ax2 and the outer surface 41e facing another direction intersecting the second rotation axis Ax2. The groove 61 has the downstream opening 66a in the outer surface 41g and the upstream opening 65a in the outer surface 41e apart from the downstream opening 66a. The filter 38 is located between the downstream opening 66a and the hole 45. Thus, the gas flow can pass through the groove 61 from one of the downstream opening 66a and the upstream opening 65a to the other. As such, the HDD 10 of the present embodiment can prevent a gas flow, when colliding with the carriage 35 and returning to the radially inside with respect to the first rotation axis Ax1, from carrying the lubricant, leading to avoiding the lubricant from contaminating, for example, the magnetic disk 12 and the magnetic head 14 located on the recording surface 12a.

The upstream opening 65a is closer to the first rotation axis Ax1 than the downstream opening 66a. Thus, the gas flow flows into the groove 61 from the upstream opening 65a and flows out of the carriage 35 from the downstream opening 66a. Further, the filter 38 is located downstream of the hole 45 in the groove 61. The gaseous or misty lubricant in the bearings 36 is discharged from the hole 45 to the groove 61 and is carried by the gas flow through the groove 61. The lubricant is then captured by the filter 38. In this manner, the HDD 10 of the present embodiment can ensure that the gaseous or misty lubricant is captured by the filter 38.

The upstream opening 65a faces the outer edge 12b of the magnetic disk 12. The gas flow is discharged from the outer edge 12b of the magnetic disk 12 in the direction along the tangent of the outer edge 12b of the magnetic disk 12. Thus, the gas flow discharged from the outer edge 12b of the magnetic disk 12 easily flows into the groove 61 from the upstream opening 65a.

In the Z direction along the first rotation axis Ax1, at least a part of the upstream opening 65a is at the same position as the recording surface 12a. Thus, the gas flow flowing along the recording surface 12a easily flows into the groove 61 from the upstream opening 65a.

The actuator assembly 15 includes the suspension 37 that holds the magnetic head 14. The suspension 37 is attached to the carriage 35. The lubricant may turn to gas or mist and adhere to the magnetic head 14, which may affect the operation of the HDD 10. However, the HDD 10 of the present embodiment includes the filter 38 to capture the gaseous or misty lubricant, to be able to prevent the lubricant from affecting the operation of the HDD 10.

The groove 61 is recessed from the end surface 41a of the carriage 35 in the +Z direction. The hole 45 opens to the bottom surface 61a of the groove 61 in the −Z direction. Thus, the groove 61 can be prevented from being closed by, for example, the FPC 18 or the retainer 19 attached to the carriage 35.

The filter 38 is located in the groove 61. Thus, the filter 38 can prevent the gas flow from passing through the gap between the filter 38 and the carriage 35 as compared with the filter covering the groove 61. Furthermore, the filter 38 can be prevented from interfering with the parts or components outside the carriage 35.

### Second Embodiment

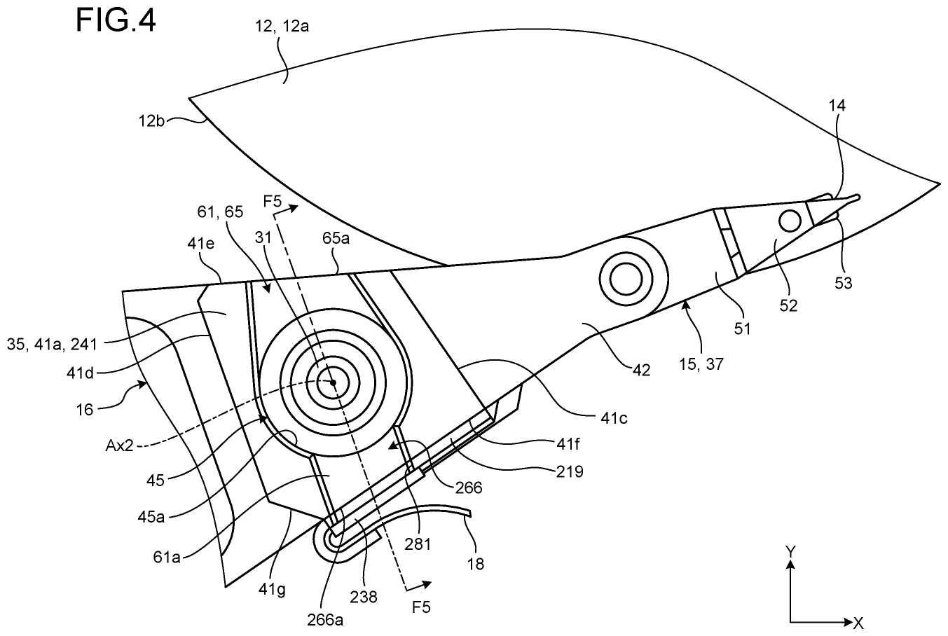

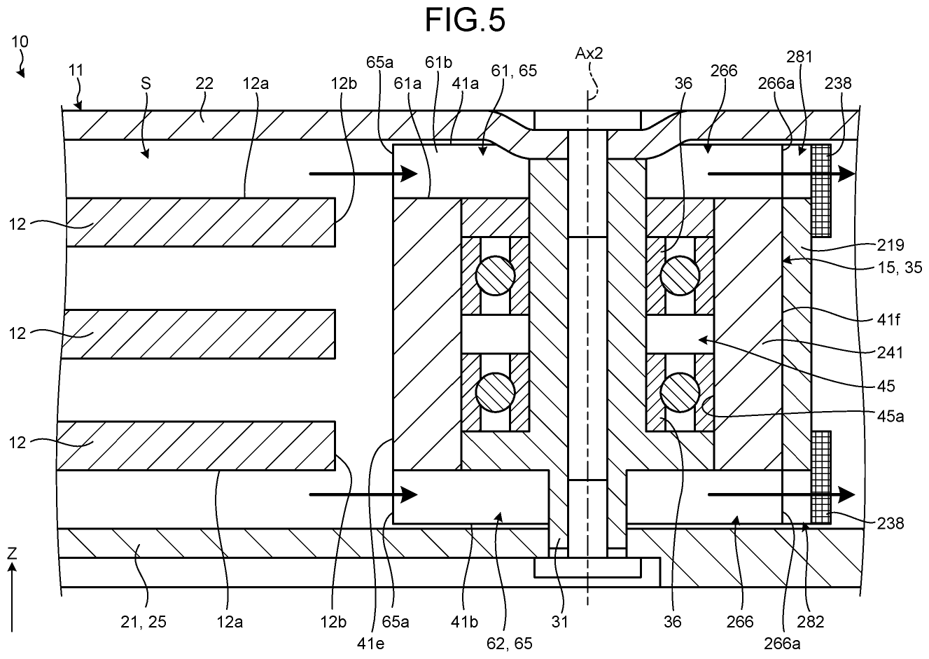

Hereinafter, a second embodiment will be described with reference to FIGS. 4 and 5. Note that in the following description of the plurality of embodiments, components having functions similar to those of the components already described are denoted by the same reference numerals as those of the components already described, and the description thereof may be omitted. In addition, the plurality of components denoted by the same reference numerals do not necessarily have all the functions and properties in common, and may have different functions and properties according to each embodiment.

FIG. 4 is an exemplary plan view schematically illustrating the actuator assembly 15 according to the second embodiment. FIG. 5 is an exemplary cross-sectional view illustrating a part of the HDD 10 of the second embodiment along line F5-F5 of FIG. 4.

As illustrated in FIG. 5, the actuator assembly 15 of the second embodiment includes a retainer 219, a filter 238, and an actuator block 241 instead of the retainer 19, the filter 38, and the actuator block 41. The retainer 219, the filter 238, and the actuator block 241 are substantially identical to the retainer 19, the filter 38, and the actuator block 41 of the first embodiment except for the points described below.

The groove 61 of the actuator block 241 has a downstream part 266 instead of the downstream part 66. The downstream part 266 is substantially identical to the downstream part 66 of the first embodiment except for the points described below. As with the groove 61, the groove 62 has the downstream part 266.

The downstream part 266 communicates with the hole 45 and the outer surface 41f. The downstream part 266 has a downstream opening 266a. The downstream opening 266a is an example of the first opening. The downstream opening 266a is substantially identical to the downstream opening 66a of the first embodiment except for the location thereof in the outer surface 41f.

The retainer 219 is provided with two cutouts 281 and 282. The cutout 281 is an example of a second communication port. The cutout 281 communicates with the downstream opening 266a of the groove 61. The cutout 282 communicates with the downstream opening 266a of the groove 62. The cutouts 281 and 282 allow the corresponding downstream openings 266a to communicate with the inner chamber S.

The actuator block 241 of the second embodiment is not provided with the groove 68. In the second embodiment, the filter 238 covers the cutout 281 or cutout 282 and the edge of the filter 238 is, for example, glued, screwed, or otherwise attached to the retainer 219. The filter 238 covers the cutouts 281 and 282 to cover the downstream opening 266a of the groove 61.

In the HDD 10 of the second embodiment described above, the retainer 219 is provided with the cutout 281 communicating with the groove 61. The filter 238 is attached to the retainer 219 to cover the groove 61 and the cutout 281. Thus, in the event that the retainer 219 covers the groove 61, the filter 238 can capture the lubricant from the gas passing through the groove 61.

### Third Embodiment

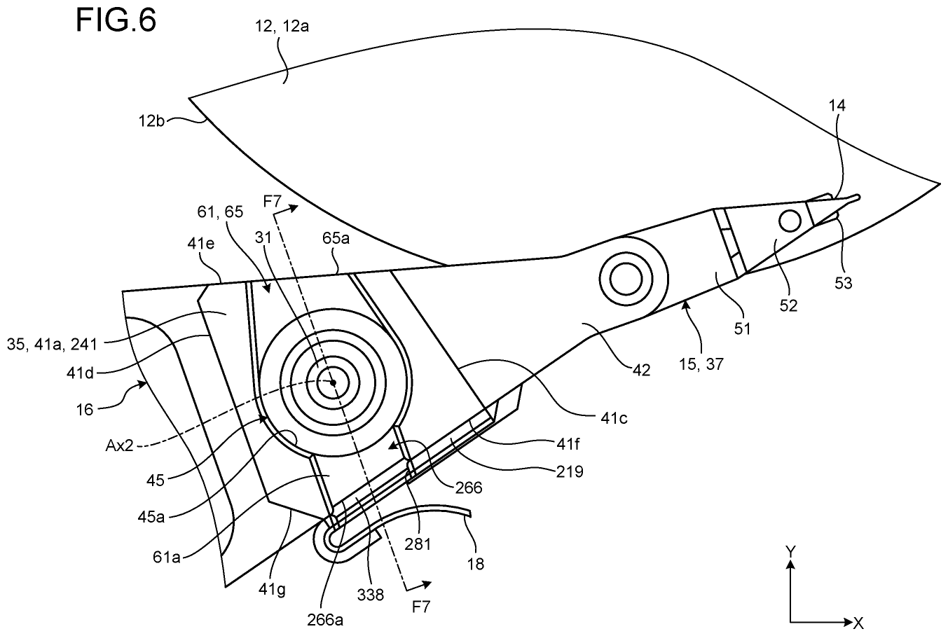

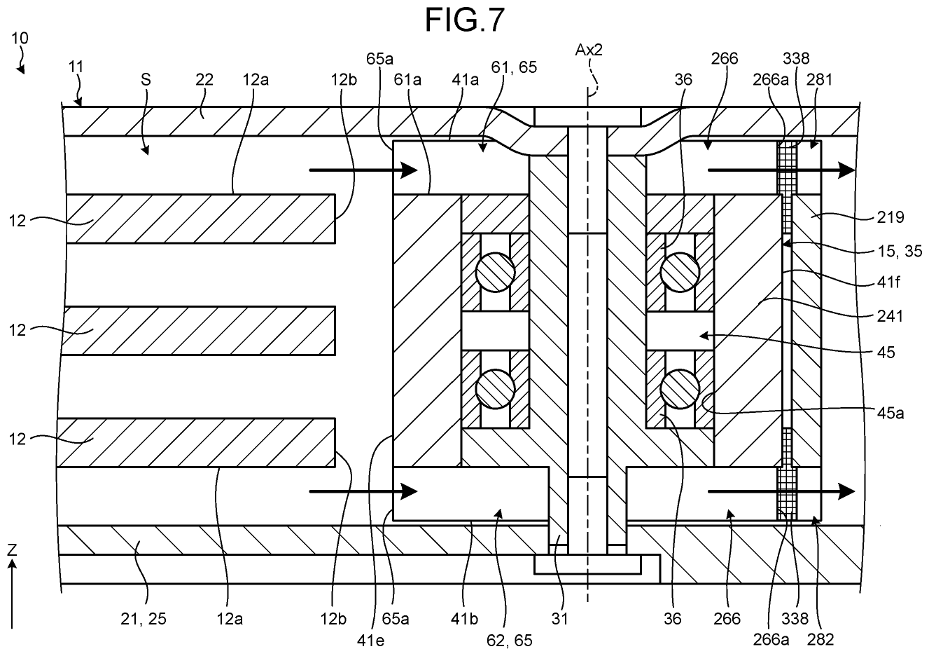

Hereinafter, a third embodiment will be described with reference to FIGS. 6 and 7. FIG. 6 is an exemplary plan view schematically illustrating the actuator assembly 15 according to the third embodiment. FIG. 7 is an exemplary cross-sectional view illustrating a part of the HDD 10 of the third embodiment along line F7-F7 of FIG. 6.

As illustrated in FIG. 7, the actuator assembly 15 of the third embodiment includes the retainer 219 and the actuator block 241 as in the second embodiment. Further, the actuator assembly 15 of the third embodiment includes a filter 338 instead of the filter 238 of the second embodiment. The filter 338 is substantially identical to the filter 238 of the second embodiment except for the points described below.

In the third embodiment, the filter 338 covers the downstream opening 266a, and for example, the edge of the filter 338 is held between the outer surface 41f of the actuator block 241 and the retainer 219. The edge of the filter 338 may be further fixed to the actuator block 241 and the retainer 219 by, for example, an adhesive. The downstream opening 266a communicates with the cutout 281 or the cutout 282 of the retainer 219 through the filter 338.

In the HDD 10 of the third embodiment described above, at least a part of the filter 338 is held between the carriage 35 and the retainer 219. This makes it easier to attach the filter 338 to the carriage 35 and the retainer 219.

### Fourth Embodiment

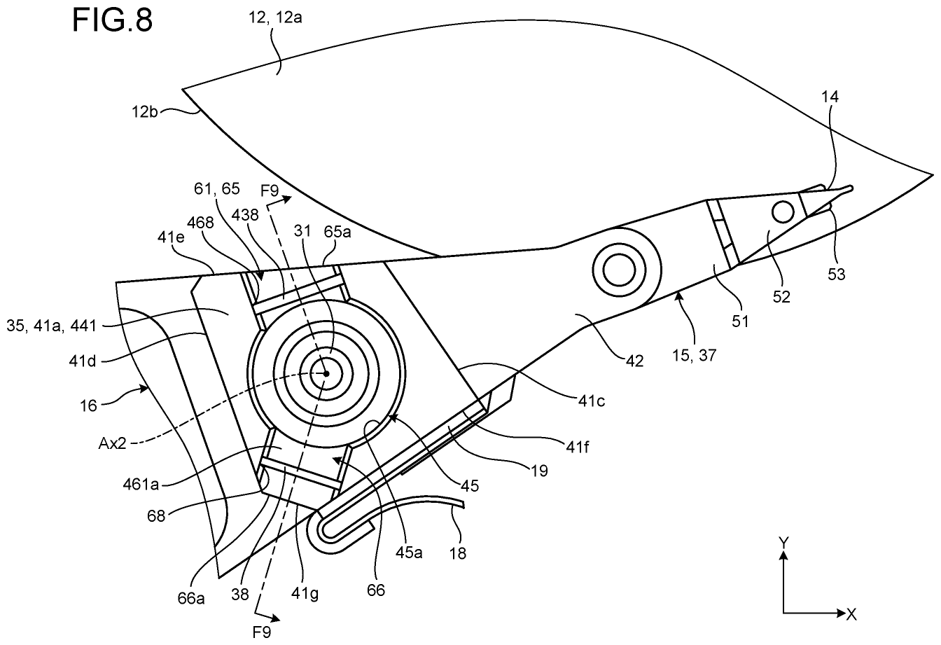

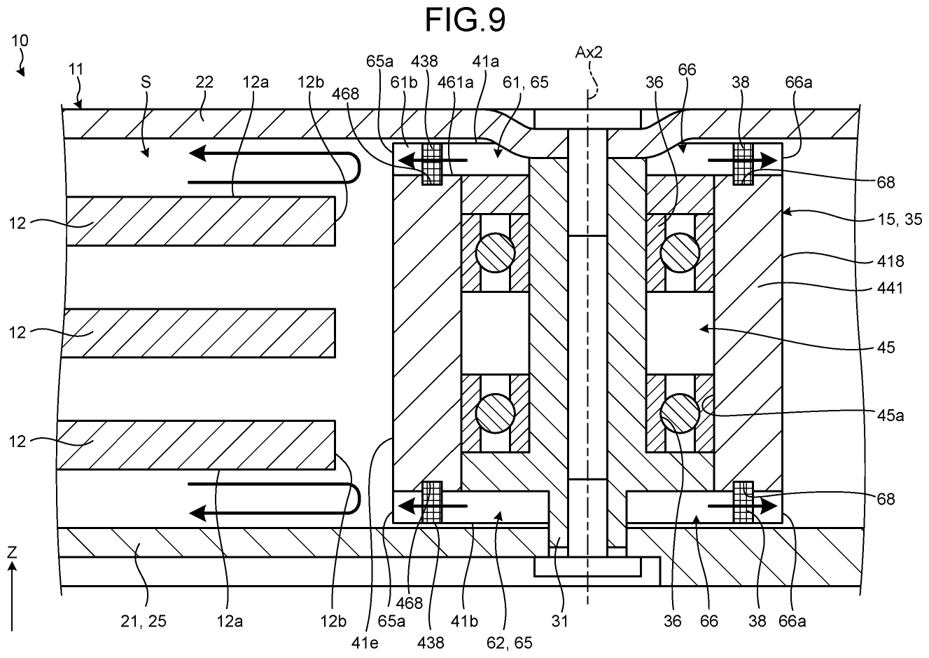

Hereinafter, a fourth embodiment will be described with reference to FIGS. 8 and 9. FIG. 8 is an exemplary plan view schematically illustrating the actuator assembly 15 according to the fourth embodiment. FIG. 9 is an exemplary cross-sectional view illustrating a part of the HDD 10 according to the fourth embodiment along line F9-F9 in FIG. 8.

As illustrated in FIG. 9, the actuator assembly 15 of the fourth embodiment includes an actuator block 441 instead of the actuator block 41. The actuator block 441 is substantially identical to the actuator block 41 of the first embodiment except for the points described below.

The actuator block 441 has a bottom surface 461a instead of the bottom surface 61a of the groove 61. The bottom surface 461a is substantially identical to the bottom surface 61a of the first embodiment except for the points described below. The bottom surface 461a is apart from the plurality of magnetic disks 12 in the +Z direction in the Z direction. In other words, the bottom surface 461a is closer to the cover 22 than the plurality of magnetic disks 12.

Due to the above arrangement of the bottom surface 461a, the upstream opening 65a of the groove 61 is apart from the plurality of magnetic disks 12 in the +Z direction in the Z direction. In other words, the upstream opening 65a is closer to the cover 22 than the plurality of magnetic disks 12. Similarly, the upstream opening 65a of the groove 62 is closer to the bottom wall 25 than the plurality of magnetic disks 12.

As illustrated in FIG. 8, the actuator assembly 15 of the fourth embodiment further includes a filter 438. The filter 438 is an example of a second filter. The filter 438 is a nonwoven fabric made of PTFE, for example, and can capture at least one component contained in the lubricant of the bearings 36. The filter 438 is disposed in the upstream part 65. In other words, the filter 438 is located between the upstream opening 65a and the hole 45.

For example, the bottom surface 461a and the two side surfaces 61b of the upstream part 65 are provided with a groove 468. The groove 468 is open to the bottom surface 461a and the two side surfaces 61b. The edge of the filter 438 is fitted into the groove 468 and fixed by adhesion, for example. Thus, the filter 438 is attached to the carriage 35. Note that the filter 438 may be attached to the carriage 35 so as to cover the upstream opening 65a.

The filter 438 protrudes in the +Z direction from the bottom surface 461a of the groove 61. Furthermore, the filter 438 is provided between the two side surfaces 61b. Thus, the filter 438 blocks the upstream part 65 but allows the gas to pass therethrough. Note that the filter 438 is not limited to this example.

In the HDD 10 of the fourth embodiment, the gas flows along the recording surface 12a of the magnetic disk 12 while being rotated about the first rotation axis Ax1 by the spindle motor 13. The gas is discharged from the outer edge 12b of the magnetic disk 12 and flows toward the actuator block 441.

The upstream opening 65a of the fourth embodiment is at a position different from the recording surface 12a in the Z direction. Thus, as indicated by arrows in FIG. 9, a flow of gas hardly flows into the upstream opening 65a, and is sucked from the outer surface 41e toward the magnetic disk 12 and circulates.

On the other hand, the lubricant of the bearings 36 turns to gas or mist and flows out from the hole 45 to the grooves 61 and 62. The lubricant flows through the grooves 61 and 62 toward the inner chamber S, for example, due to a pressure difference caused by the circulating gas flow.

Due to the pressure difference, the lubricant may flow toward the upstream opening 65a or may flow toward the downstream opening 66a. Since the filter 438 is provided in the upstream part 65 and the filter 38 is provided in the downstream part 66, the lubricant flowing toward either the upstream opening 65a or the downstream opening 66a is also captured by the filter 38 or the filter 438.

In the HDD 10 of the fourth embodiment described above, the filter 438 is located between the upstream opening 65a and the hole 45 or covers the upstream opening 65a. Thus, the filters 38 and 438 can prevent the lubricant in the bearings 36 discharged from the hole 45 to the groove 61 from flowing out of the carriage 35 from the upstream opening 65a and the downstream opening 66a. In this manner, the HDD 10 of the present embodiment can be avoided from being contaminated inside due to the gaseous or misty lubricant.

### Fifth Embodiment

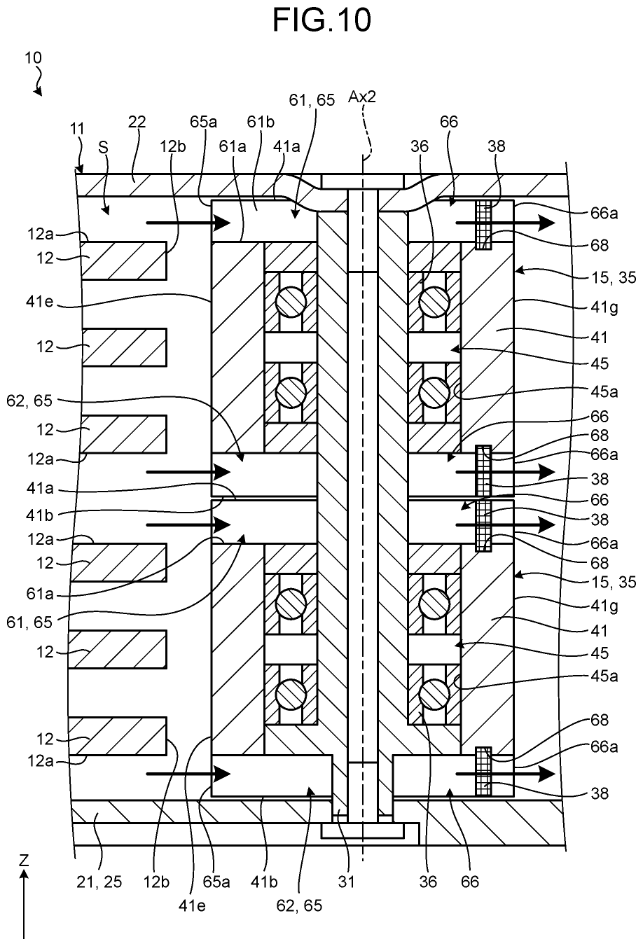

Hereinafter, a fifth embodiment will be described with reference to FIG. 10. FIG. 10 is an exemplary cross-sectional view illustrating a part of the HDD 10 according to the fifth embodiment. As illustrated in FIG. 10, the HDD 10 according to the fifth embodiment is what is called a multi-actuator HDD having a plurality of actuator assemblies 15.

In each of the plurality of actuator assemblies 15, the bottom surface 61a of the groove 61 is at substantially the same position as the recording surface 12a of the corresponding one of the plurality of magnetic disks 12 in the Z direction. Due to the arrangement of the bottom surface 61a, at least a part of the upstream opening 65a is located at the same position as one corresponding recording surface 12a among the plurality of magnetic disks 12 in the Z direction.

In the HDD 10 of the fifth embodiment described above, the upstream openings 65a of the actuator assemblies 15 are at least partially at the same position as the corresponding recording surfaces 12a of the magnetic disks 12 in the Z direction. Because of this, the gas flow occurring from at least one of the inner-side magnetic disks 12 can pass through the grooves 61 and 62.

Note that FIG. 10 illustrates an example that the HDD 10 includes the actuator assemblies 15 of the first embodiment. However, the HDD 10 of the fifth embodiment may have the actuator assemblies 15 of the second embodiment, the actuator assemblies 15 of the third embodiment, or the actuator assemblies 15 of the fourth embodiment.

In the plurality of embodiments described above, the groove 61 has the upstream opening 65a and the downstream opening 66a. However, the first communication port may have one opening or three or more openings. In addition, the first communication port is not limited to the groove 61, and may be a hole.

In the above description, “prevent” is defined as, for example, to prevent the occurrence of an event, an action, or an influence, or reduce the degree of the event, the action, or the influence. Furthermore, in the above description, “restrict” is defined as, for example, to prevent movement or rotation, or allow movement or rotation within a predetermined range and prevent movement or rotation beyond the predetermined range.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a magnetic disk being rotatable about a first rotation axis extending in the first direction, and having a recording surface facing a first direction; and
a rotary unit comprising:
a rotary member,
a bearing containing a lubricant and rotatably supporting the rotary member about a second rotation axis extending in the first direction, the second rotation axis being apart from the first rotation axis in a second direction orthogonal to the first direction, and
a first filter that captures at least one component contained in the lubricant, wherein the rotary member is provided with:
a hole extending along the second rotation axis to accommodate the bearing, and
a first communication port extending in a direction intersecting the second rotation axis to allow the hole to be in communication with an outside of the rotary member, and
the first filter is disposed in the first communication port or covers the first communication port.

2. The disk device according to claim 1, wherein
the rotary member has a first outer surface facing a third direction intersecting the second rotation axis, and a second outer surface facing a fourth direction, the fourth direction intersecting the second rotation axis and being a direction different from the third direction,
the first communication port has a first opening to the first outer surface and a second opening to the second outer surface, the second opening being apart from the first opening, and
the first filter is disposed between the first opening and the hole or covers the first opening.

3. The disk device according to claim 2, wherein
the second opening is closer to the first rotation axis than the first opening.

4. The disk device according to claim 3, wherein
the second opening faces an end of the magnetic disk in a direction orthogonal to the first rotation axis.

5. The disk device according to claim 4, wherein
at least a part of the second opening is located at a same position as the recording surface in a direction along the first rotation axis.

6. The disk device according to claim 2, further comprising:
a second filter that captures at least one component contained in the lubricant, the second filter being disposed between the second opening and the hole or covering the second opening.

7. The disk device according to claim 1, further comprising:
a magnetic head configured to read and write information from and to the recording surface, wherein
the rotary unit comprises a suspension that holds the magnetic head, and
the rotary member comprises a carriage to which the suspension is attached.

8. The disk device according to claim 7, wherein
the first communication port is provided with a groove recessed from an end of the carriage in the first direction, and
the hole opens to a bottom surface of the groove in a direction opposite to the first direction.

9. The disk device according to claim 1, wherein
the first filter is disposed in the first communication port.

10. The disk device according to claim 7, further comprising:
a flexible printed circuit board; and
a retainer attached to the carriage and holding the flexible printed circuit board, wherein
the retainer is provided with a second communication port communicating with the first communication port, and
the first filter is attached to the retainer, to cover the first communication port and the second communication port.

11. The disk device according to claim 7, further comprising:
a flexible printed circuit board; and
a retainer attached to the carriage and holding the flexible printed circuit board, wherein
at least a part of the first filter is held between the carriage and the retainer.
